(19) United States
(12) Patent Application Publication
(10) Pub. No.: US 2008/0195418 A1
(43) Pub. Date: Aug. 14, 2008

(54) Method for generating a prescription for orthodontic appliances

(76) Inventors: Stephen H. Parker, Gates Mills, OH (US); Ronald G. Urbassik, Painesville, OH (US)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 12/069,589

(22) Filed: Feb. 12, 2008

Related U.S. Application Data
(60) Provisional application No. 60/901,884, filed on Feb. 13, 2007.

(51) Int. Cl. G06Q 50/00

(52) U.S. Cl. 705/2

(57) ABSTRACT

A prescription for an orthodontic appliance is generated with a method using a computer-based program. The method includes providing a list of orthodontic appliances. From the list, an orthodontist may select an orthodontic appliance using a computer interface. The method also includes depicting a pictorial representation of the orthodontic appliance selected with a representation of the patient's maxillary and mandibular arches and providing a written description of the orthodontic appliance selected. The prescription is then sent to an orthodontic manufacturing lab. In one embodiment, the computer based program is installed on a computer system in an orthodontic clinic. In another embodiment, the computer based program is accessed by connecting to a web site. The web site may be operated by the orthodontic manufacturing lab or the supplier of the computer-based program.

### REFERENCE TO RELATED APPLICATIONS

This application claims priority under 35 U.S.C. §119(e) to U.S. Provisional Patent Application No. 60/901,884 filed Feb. 13, 2007.

### BACKGROUND OF THE INVENTION

1. Field of Invention

This invention relates to the field orthodontics, and more particularly, relates to an improved method for designing and ordering orthodontic appliances for a patient.

2. Description of Related Art

Orthodontics is the practice of repositioning a patient's teeth to improve dental function and/or cosmetic appearance. Typically, with any treatment, an initial mold of the patient's teeth is made. This mold provides a model of the patient's teeth that the orthodontist uses to formulate a treatment strategy. The orthodontic practitioner creates a desired treatment plan by selecting components that apply gentle pressure to the teeth in certain directions. Over a period of time, the teeth tend to slowly shift toward the desired orthodontically correct positions along the dental arch. Once the teeth have been moved to the desired location and are held in place for a certain period of time, the body adapts bone and tissue to maintain the teeth in the desired location.

The repositioning of the patient's teeth may be accomplished using a variety of orthodontic appliances, including fixed appliances, removable appliances, functional appliances and palatal expanders, using a variety of brackets, bands, arch wires, lip bumpers, facebows and other components known in the art. For example, one type of orthodontic treatment that is in widespread use comprises a set of orthodontic appliances along with an archwire. The appliances typically include a number of small, slotted brackets, each of which is mounted on a corresponding tooth along the dental arch. The archwire is received in the slot of each bracket and forms a track to guide the teeth toward desired positions. Usually, a set of appliances and an archwire are provided for both the upper and the lower dental arch of the patient, and treatment of both arches is carried out at the same time. Typically, after a period of time, the brackets are removed and a removable retainer is used to further assist in retaining the teeth in the desired location.

In practice, after the orthodontist has selected the desired treatment plan, the required orthodontic appliances are ordered from an orthodontic lab that specializes in manufacturing orthodontic appliances. The orthodontist typically handwrites a prescription on a diagram of an upper and lower dental arch and submits the prescription to the manufacturing lab. The dental appliances are then fabricated and provided to the orthodontist. This process can be time consuming and illegible handwriting and inaccurate drawings may lead to incorrect fabrication of the appliances. As can be appreciated, it would be desirable to provide a method and system for facilitating the preparation of orthodontic appliance prescriptions, and in particular, to provide a computer-based method for facilitating the generation of prescriptions. Desirably, such a method would be easy to use and would generate consistently legible prescriptions adaptable for use with any type of orthodontic appliance and with any orthodontic manufacturing lab.

### SUMMARY OF THE INVENTION

The invention is directed to an improved method of generating a prescription for orthodontic appliances using a computer-based program. The method includes providing a list of orthodontic appliances. From the list, an orthodontist may select an orthodontic appliance using a computer interface. The method also includes depicting a pictorial representation of the selected orthodontic appliance on a representation of the patient's maxillary and mandibular arches and providing a written description of the orthodontic appliance selected. The prescription is then sent to an orthodontic manufacturing lab. In one embodiment, the computer based program is installed on a computer system in an orthodontic clinic. In another embodiment, the computer based program is accessed by connecting to a web site. The web site may be operated by the orthodontic manufacturing lab or the supplier of the computer-based program.

These and other features and advantages of this invention are described in, or are apparent from, the following detailed description of various exemplary embodiments of the systems and methods according to this invention.

### BRIEF DESCRIPTION OF THE DRAWINGS

The structure, operation, and advantages of the presently disclosed embodiment of the invention will become apparent when consideration of the following description taken in conjunction with the accompanying drawings wherein:

FIG. 1 is a screen display from a computer-based orthodontic prescription generation method that allows an orthodontist to select an orthodontic appliance;

FIG. 2 is an additional screen display from the computer-based orthodontic prescription generation method of FIG. 1;

FIG. 3 is an additional screen display from the computer-based orthodontic prescription generation method of FIG. 1 illustrating a library of orthodontic appliances;

FIG. 4 is an additional screen display from the computer-based orthodontic prescription generation method of FIG. 1;

FIG. 5 is an additional screen display from the computer-based orthodontic prescription generation method of FIG. 1;

FIG. 6 is an additional screen display from the computer-based orthodontic prescription generation method of FIG. 1 showing the completed prescription;

FIG. 7 is a printout of the completed prescription suitable for sending to an orthodontic appliance manufacturing lab;

FIG. 8 illustrates the computer-based orthodontic prescription generation method as used with a web-based interface; and

FIG. 9 illustrates the computer-based orthodontic prescription generation method as used with a lab-based interface.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

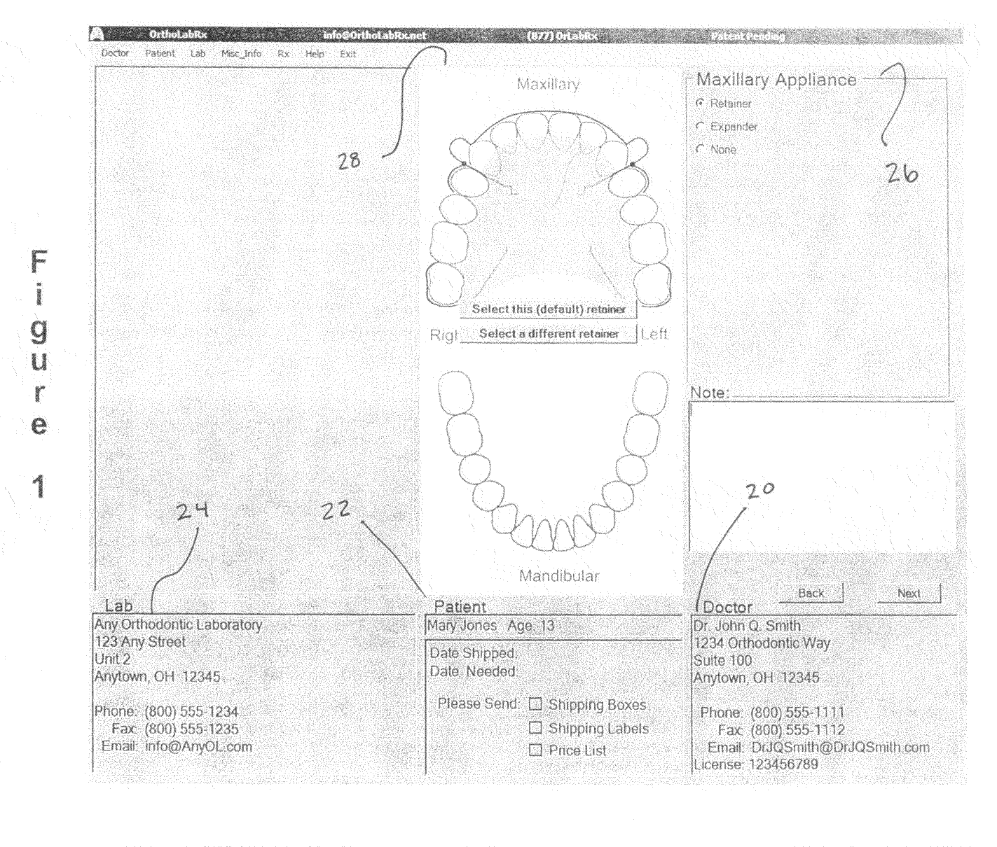

Referring now to the drawings, FIGS. 1-6 illustrate a computer-based method of generating prescriptions for orthodontic appliances according to an embodiment of the invention. The illustrated embodiment provides an improved method by which an orthodontist can send out lab prescriptions for any given orthodontic appliance. For ease of understanding and clarity, the prescription generating method will be mainly described below using software-generated screen displays that are displayed on a user interface and the key functionality in the screen displays. A person skilled in the art will be able to program a computer to provide these functions from the present description and representative screen displays.

The user of the prescription generating method can be an orthodontist or some other orthodontic technician having the knowledge of one skilled in the art of the orthodontic appliances to be ordered in accordance with the method. As seen in FIG. 1, information about the orthodontist generating the prescription can be entered and stored by the computer program. In block 22, information about a patient can be entered in block 20 and stored by the computer program. In block 24, information about the orthodontic lab that is selected to manufacture the appliances can be entered and stored by the computer program. The manufacturing laboratory can be any conventional orthodontic appliance manufacturing laboratory capable of manufacturing known orthodontic appliances such as fixed appliances, removable appliances, functional appliances, palatal expanders, and the like, and the necessary brackets, bands, arch wires, lip bumpers, facebows and other components known in the art. Desirably, the computer-based method allows information about one or more orthodontic supply labs to be stored and easily retrieved.

The computer-based method allows the orthodontist to select the orthodontic appliances desired to treat the patient, including, for example, the type of retainer, expander, support wires, and the like. In block 26, possible orthodontic appliance selections are listed. One skilled in the art will appreciate that any known orthodontic appliance may be listed by the program. Desirably, the orthodontist chooses a selection from the listed appliances. In block 28, a pictorial representation of the orthodontic appliance is represented on a diagram of an upper or maxillary and a lower or mandibular dental arch. In one desired embodiment, a default appliance is initially represented by the computer program and the orthodontist may select the default appliance or change to a different appliance.

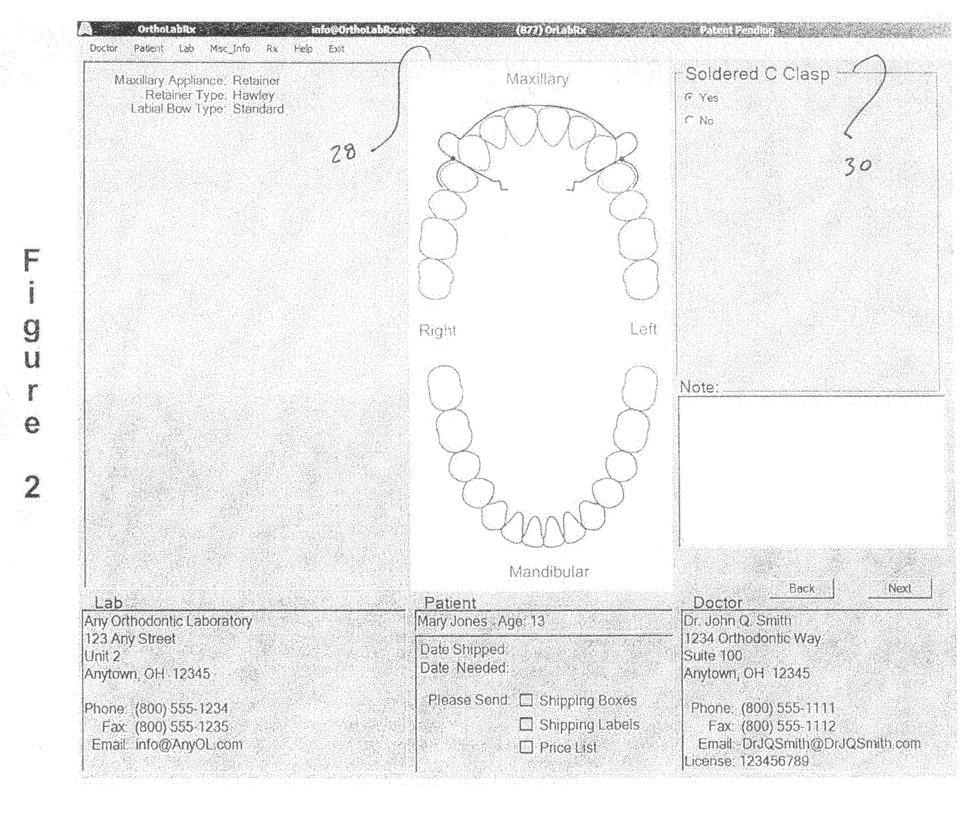

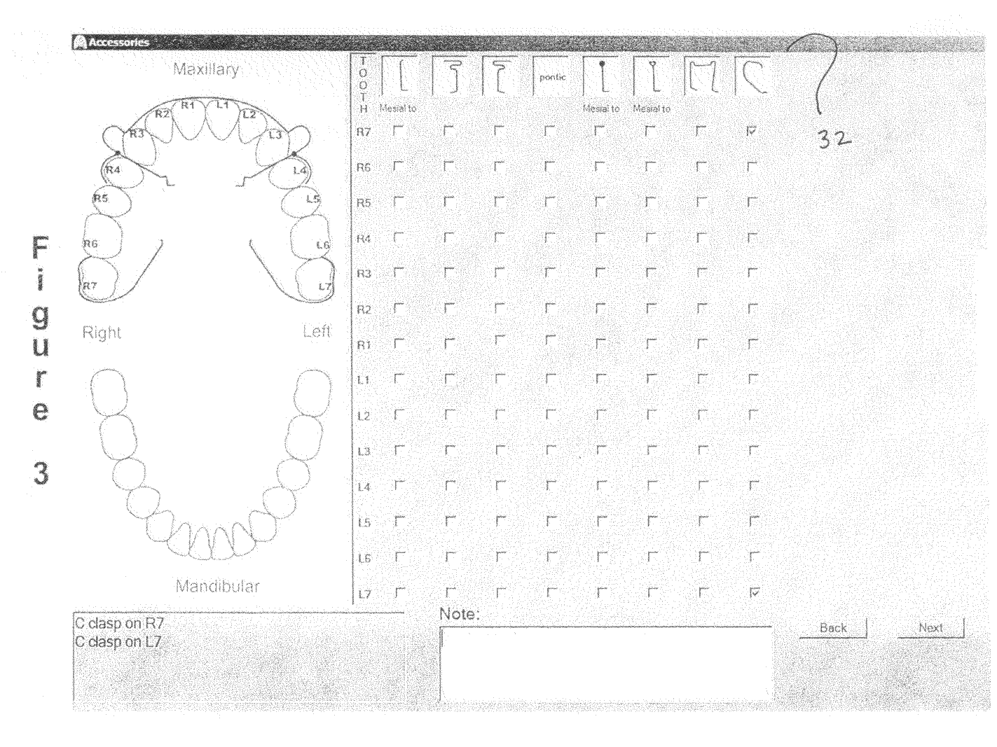

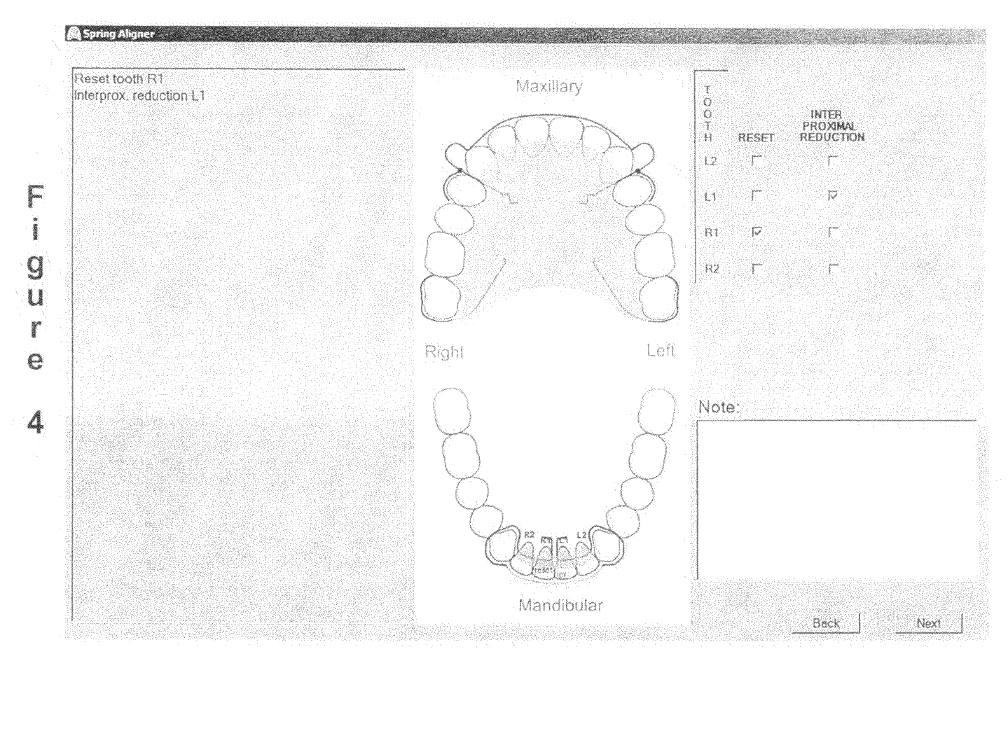

Turning now to FIG. 2, after an initial appliance selection has been made, the selected appliance is illustrated pictorially on the diagram of the upper and lower dental arch in bock 28. Depending on the appliance selected, further accessories or components may be selected as illustrated in block 30. As seen in FIG. 3, the prescription generating method provides a library of possible accessories and permits the orthodontist to select the desired accessory and the tooth on which the accessory is used in block 32. FIG. 4 displays the ability to tell the laboratory which teeth need to be repositioned and the amount and location of tooth reduction desired for these teeth if needed. The illustrated embodiment shows its use for a spring aligner appliance. However, one skilled in the art will understand that it could be applied to a variety of other appliances.

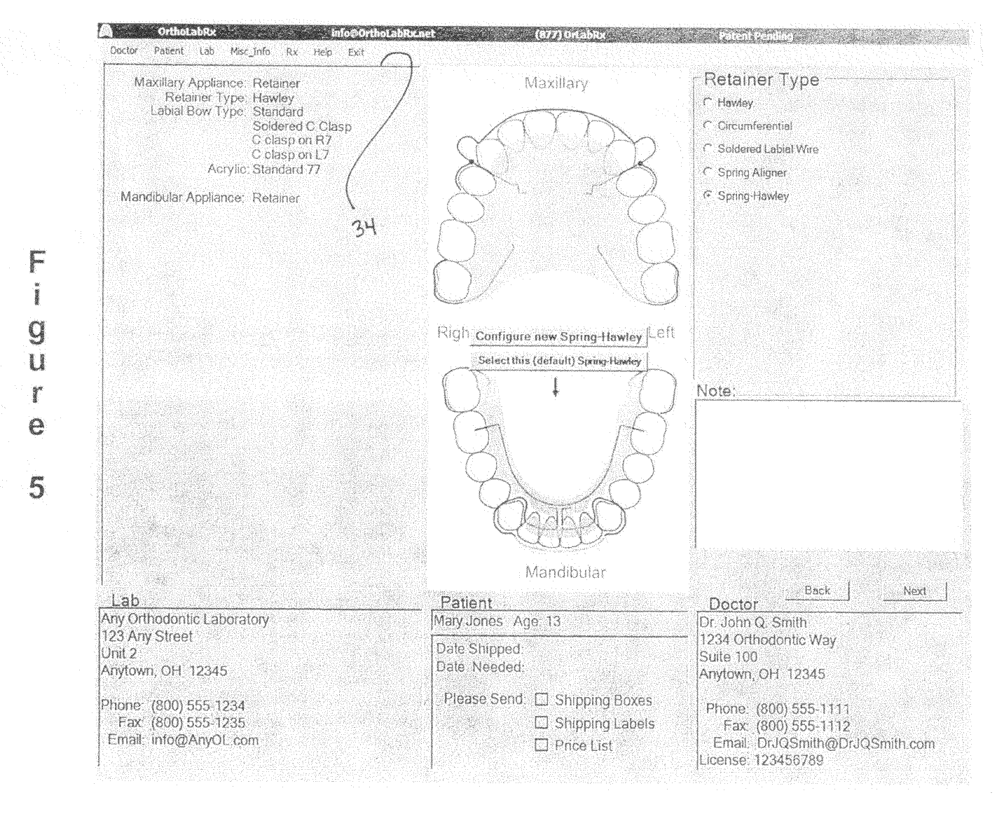

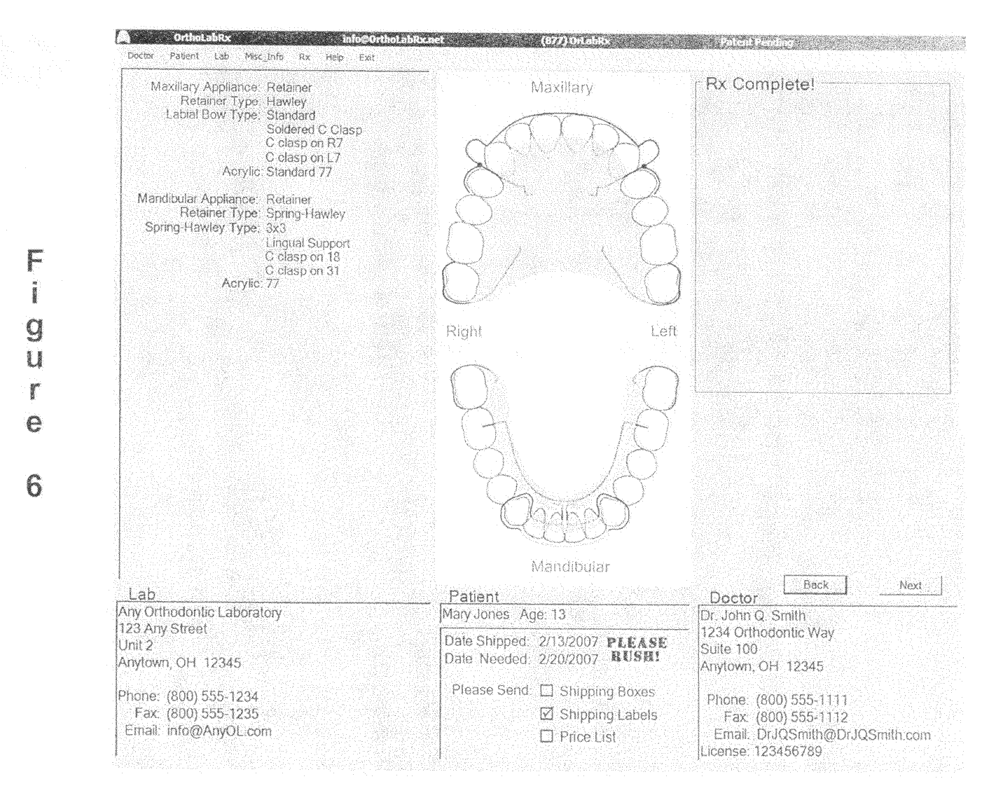

As seen in FIG. 5, after the appliance for the top or maxillary tooth arch has be entered in the program, a summary of the type of appliance and its particulars is shown in block 34. The orthodontist may then select the desired appliance for the lower or mandibular tooth arch. The process for selecting the appliance for the lower tooth arch is desirably substantially the same as the process used to select the process for the top arch. After the desired selection is made, the completed prescription is pictorially represented in block 28 and the complete prescription summary is listed in block 34 as shown in FIG. 6.

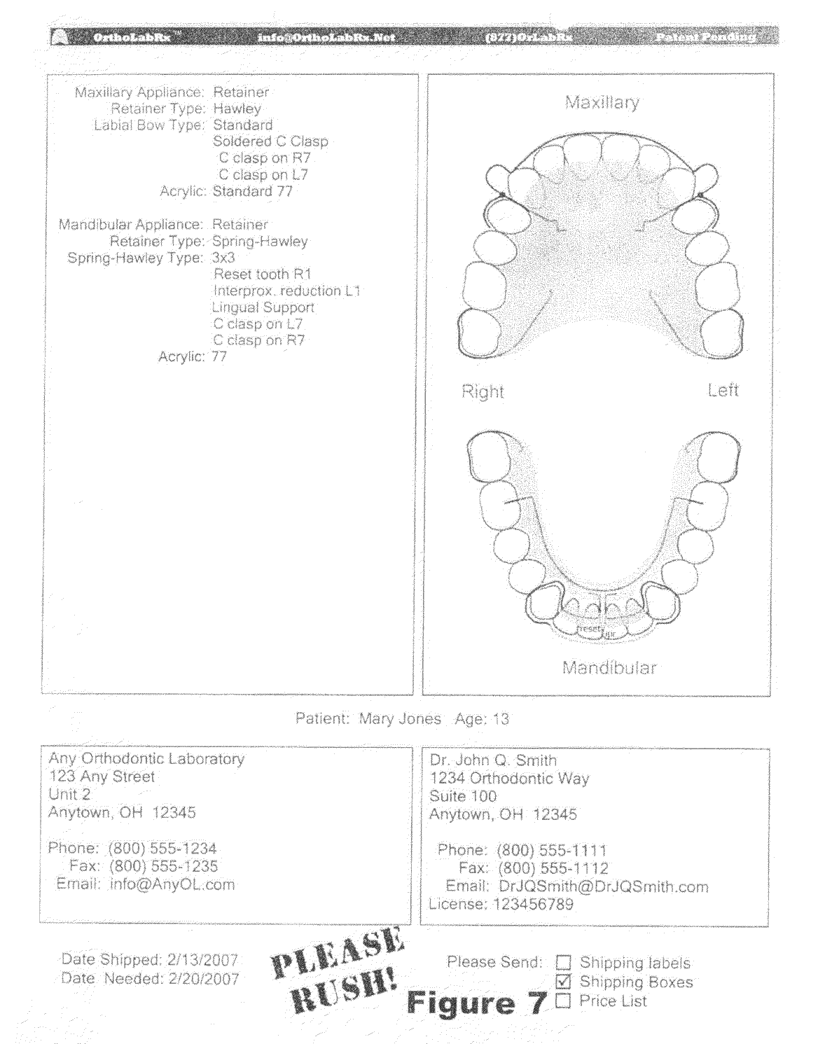

Referring now to FIG. 7, the computer-based method generates an appliance prescription that is sent to the lab that includes the components required for fabrication of the specific appliance for the selected treatment. The orthodontist can then make one or more printouts of the prescription. One copy of the printout is sent to the manufacturing laboratory by the orthodontist. Another copy may be retained by the orthodontist for record keeping purposes. The order can be sent to the lab via email directly from the computer, or can be printed and sent via facsimile or other suitable method. Therefore, it can be seen that the improved method allows the doctor to quickly generate an appliance order and send it to the desired lab. The computer-based method for generating orthodontic prescriptions as set forth results in method that is more efficient for the orthodontist since it permits the use of a computer rather than the laborious writing of the prescription by hand. The method reduces the potential for error associated with illegible handwriting and drawings. It also provides a systematic and uniform method to generate and store an electronic record of the patient prescription.

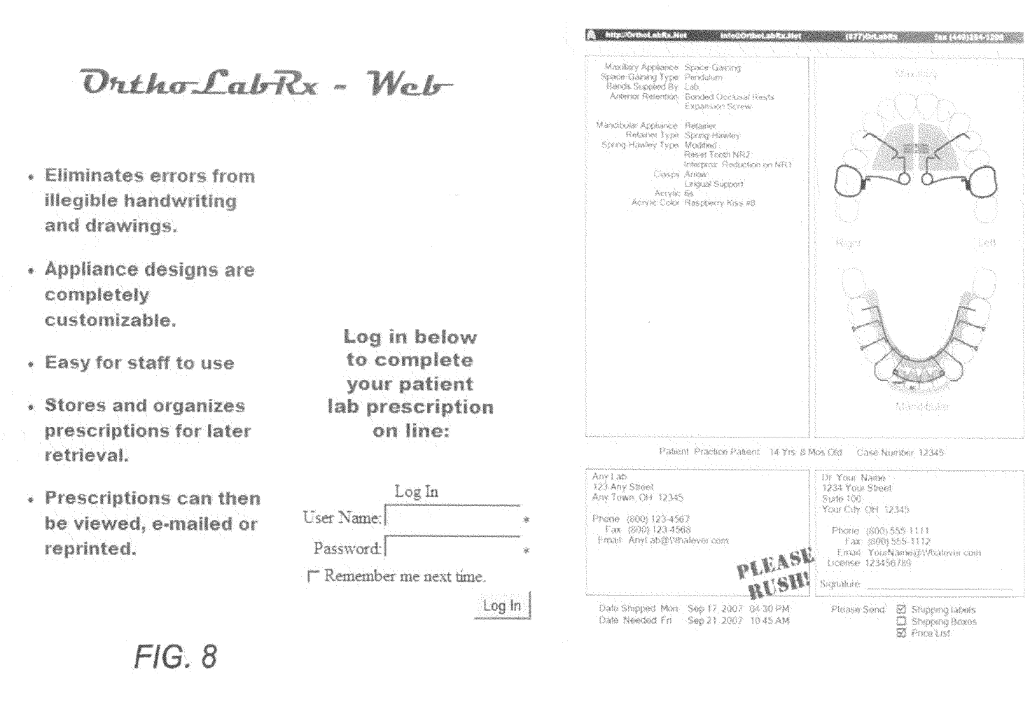

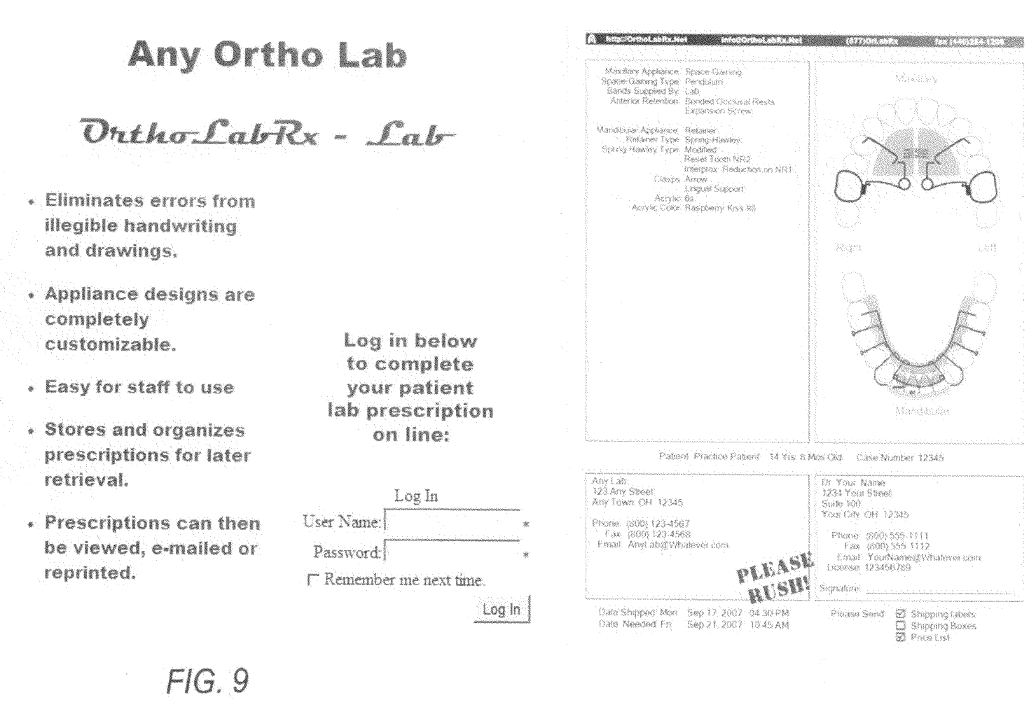

In the illustrated embodiment described hereto, it is contemplated that most if not all aspects of the prescription generating method software will ordinarily be installed on a back office server or workstation in an orthodontic clinic. However, the prescription generating method permits the use of an internet connection to perform the operations generating the prescription and sending it to the lab. As seen in FIG. 8, the software may be accessed by connecting to a web site. The orthodontist may obtain a subscription to use the software via the web site and enter a user name and password to gain access to the prescription generating method. The final prescription, substantially similar to the one described above with respect to FIG. 7 may be printed out or sent directly to the lab via email. FIG. 9 illustrates a third interface in which the prescription generating software is accessed on a web site that is hosted by the manufacturing laboratory performing the manufacturing of the orthodontic appliances. Thus, the orthodontist may enter the prescription and place the order by way of the internet and the web site of the manufacturing laboratory. In all cases, the base method of entering the prescription using a computer based prescription generating method is substantially the same.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A method of generating a prescription for an orthodontic appliance using a computer-based program, the method comprising the steps of:
providing a list of orthodontic appliances;
selecting an orthodontic appliance from the list of orthodontic appliances using a computer interface;
depicting a pictorial representation of the orthodontic appliance selected with a representation of the patient's maxillary and mandibular arches;
providing a written description of the orthodontic appliance selected;
sending the prescription to an orthodontic manufacturing lab.

2. The method of claim 1 further comprising providing a library of possible accessories for the appliance and using a computer interface to select at least one accessory and a tooth to which the accessory is to be matched, wherein the accessory is illustrated on the pictorial representation.

3. The method of claim 1 wherein the computer based program is installed on a computer system in an orthodontic clinic.

4. The method of claim 1 wherein the computer based program is accessed by connecting to a web site.

5. The method of claim 1 wherein the web site is a web site of the orthodontic manufacturing lab.
